(19) United States
(12) Patent Application Publication
(10) Pub. No.: US 2024/0284311 A1
(43) Pub. Date: Aug. 22, 2024

(54) APPARATUS AND METHOD FOR NETWORK SLICE ACCESS GROUP (NSAG) USAGE IN A WIRELESS COMMUNICATION SYSTEM

(71) Applicant: Samsung Electronics Co., Ltd., Suwon-si (KR)

(72) Inventors: Mahmoud WATFA, Staines (GB); Chadi KHIRALLAH, Staines (GB); Lalith KUMAR, Bangalore (IN)

(21) Appl. No.: 18/429,917

(22) Filed: Feb. 1, 2024

(30) Foreign Application Priority Data
Feb. 16, 2023 (IN) 202331010327
Jan. 11, 2024 (GB) 2400418.6

(51) Int. Cl. H04W 48/14; H04W 60/06

(52) U.S. Cl. CPC H04W 48/14; H04W 60/06

(57) ABSTRACT

The disclosure relates to a fifth generation (5G) or sixth generation (6G) communication system for supporting a higher data transmission rate. A method performed by a user equipment (UE) in a wireless communication system is provided. The method includes identifying a reason for an access attempt, and determining, based on the reasons for the access attempt, whether to provide at least one single network slice selection assistance information (S-NSSAI) related to the access attempt from a non-access stratum (NAS) layer to a lower layer.

### CROSS-REFERENCE TO RELATED APPLICATION(S)

This application is based on and claims priority under 35 U.S.C. § 119(a) of an Indian patent application number 202331010327, filed on Feb. 16, 2023, in the Indian Intellectual Property Office, and of a United Kingdom patent application number 2400418.6, filed on Jan. 11, 2024, in the United Kingdom Intellectual Property Office, the disclosure of each of which is incorporated by reference herein in its entirety.

### BACKGROUND

### 1. Field

The disclosure relates to a telecommunication network. More particularly, the disclosure relates to one that employs network slicing. Various Embodiments of the disclosure find particular, but not exclusive use in Fifth Generation (5G) networks, but the skilled person will appreciate that the teaching herein can be applied in a variety of networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as millimeter-wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random-access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A set of slices, Single—Network Slice Selection Assistance Information (S-NSSAI), may be known to be part of a group, where the set of slices may be optionally valid with a set of Tracking Area Identities (TAIs), if available, and a certain priority level may also be associated with these slices—and hence the group. If the list of TAIs is not available, then the slices are valid in the entire Public Land Mobile Network (PLMN). The following is an excerpt from section 4.6.2.6 of TS 24.501 about NSAG:
“The NSAG information provided by the network and stored in the User Equipment (UE) includes a list of NSAGs each of which contains:
a) an NSAG ID;
b) a list of S-NSSAI(s), which are associated with the NSAG and shall be part of the configured NSSAI;
c) a priority value that is associated with the NSAG; and
d) optionally a list of TAIs in which the NSAG is valid. If it is not provided by the network, the NSAG is valid in the PLMN which has sent the NSAG information.

The UE NAS layer shall provide the lower layers with.
a) the most recent NSAG information stored in the UE (see subclause 4.6.2.2);
b) the allowed NSSAI or the requested NSSAI for the purpose of network slice-based cell reselection (see 3GPP TS 23.501); and
c) one or more S-NSSAIs related to an access attempt for the purpose of network slice-based random access, when the access attempt is made by the UE in 5GMM-IDLE mode or 5GMM-CONNECTED mode with RRC inactive indication, determined as follows:
i) S-NSSAI(s) triggering the initial NAS message (requested NSSAI (if any) in case of the REGISTRATION REQUEST message and S-NSSAI(s) associated with all the PDU sessions included in the Uplink data status IE (if any), PDU session status IE (if any), or Allowed PDU session status IE (if any) in case of the (CONTROL PLANE) SERVICE REQUEST message), if an access attempt occurred due to an initial NAS message;
ii) the S-NSSAI associated with the PDU session, if an access attempt occurred due to an uplink user data packet to be sent for a PDU session with suspended user-plane resources or an UL NAS TRANSPORT which carries a 5GSM message for a PDU session associated with an S-NSSAI (if any); or
iii) the allowed NSSAI (if any), if an access attempt occurred for other reason than those specified in bullets i) and ii).
Editor's note: It is For Further Study (FFS) how a UE operates in terms of NSAG if the UE has an emergency PDU session or attempts to establish an emergency PDU session.
NOTE: The AMF can take local configuration, UE 5GMM capabilities, subscribed S-NSSAIs, HPLMN, etc. to determine the NSAG priority information for the associated NSAG to a UE.”

Service area restrictions define so called non-allowed areas in which a UE is not able to receive normal services except for emergency services or high priority services (e.g. when the UE is a high priority access UE). The UE can be in a non-allowed area either when the current Tracking Area Identity (TAI) is part of the non-allowed area (which is indicated in the Service area list Information Element (IE)), or when the UE is in a TAI which is outside the TAIs that are considered to be allowed TAIs (where the allowed TAIs can also be indicated in the Service area list IE). The following is from section 5.3.5 of TS 24.501 which describes the details of service area restrictions:
“The service area restrictions consist of tracking areas forming either an allowed area, or a non-allowed area. The tracking areas belong to either the registered PLMN or its equivalent PLMNs in the registration area. The allowed area can contain up to 16 tracking areas or include all tracking areas in the registered PLMN and its equivalent PLMN(s) in the registration area. The non-allowed area can contain up to 16 tracking areas. The network conveys the service area restrictions to the UE by including either an allowed area, or a non-allowed area, but not both, in the Service area list IE of a REGISTRATION ACCEPT message or a CONFIGURATION UPDATE COMMAND message.
If the network does not convey the service area restrictions to the UE in the Service area list IE of a REGISTRATION ACCEPT message, the UE shall treat all tracking areas in the registered PLMN and its equivalent PLMN(s) in the registration area as allowed area and delete the stored list of “allowed tracking areas” or the stored list of “non-allowed tracking areas”.

When the UE receives a Service area list IE with an allowed area indication during a registration procedure or a generic UE configuration update procedure:
a) if the “Type of list” included in the Service area list IE does not indicate “all TAIs belonging to the PLMNs in the registration area are allowed area”, the UE shall delete the old list of “allowed tracking areas” and store the tracking areas in the allowed area as the list of “allowed tracking areas”. If the UE has a stored list of “non-allowed tracking areas”, the UE shall delete that list; or
b) if the “Type of list” included in the Service area list IE indicates “all TAIs belonging to the PLMNs in the registration area are allowed area”, the UE shall treat all tracking areas in the registered PLMN and its equivalent PLMN(s) as allowed area and delete the stored list of “allowed tracking areas” or the stored list of “non-allowed tracking areas”.

When the UE receives a Service area list IE with a non-allowed area indication during a registration procedure or a generic UE configuration update procedure, the UE shall delete the old list of “non-allowed tracking areas” and store the tracking areas in the non-allowed area as the list of “non-allowed tracking areas”. If the UE has a stored list of “allowed tracking areas”, the UE shall delete that list.

If the UE is successfully registered to a PLMN and has a stored list of “allowed tracking areas”:
a) while the current TAI is in the list of “allowed tracking areas”, the UE shall stay in, or enter, the state 5GMM-REGISTERED.NORMAL-SERVICE and is allowed to initiate any 5GMM and 5GSM procedures; and
b) while the UE is camped on a cell which is in the registered PLMN or a PLMN from the list of equivalent PLMNs and the current TAI is not in the list of “allowed tracking areas”, the UE shall enter the state 5GMM-REGISTERED.NON-ALLOWED-SERVICE, and:
1) if the UE is in 5GMM-IDLE mode or 5GMM-IDLE mode with suspend indication over 3GPP access, the UE:
i) shall not include the Uplink data status IE in the registration procedure for mobility and periodic registration update except for emergency services or for high priority access;
ii) shall not perform the registration procedure for mobility and periodic registration update with Follow-on request indicator set to “Follow-on request pending”, except for:
   emergency services;
   high priority access;
   indicating a change of 3GPP PS data off UE status;
   sending an SOR transparent container;
   sending a UE policy container; or
   sending a UE parameters update transparent container;
iii) shall not initiate a service request procedure or request the lower layers to resume a suspended connection, except for:
   emergency services;
   emergency services fallback;
   high priority access;
   responding to paging;
   responding to notification received over non-3GPP access;
   indicating a change of 3GPP PS data off UE status;
   sending an SOR transparent container;
   sending a UE policy container; or
   sending a UE parameters update transparent container; and
2) if the UE is in 5GMM-CONNECTED mode or 5GMM-CONNECTED mode with RRC inactive indication over 3GPP access, the UE:
i) shall not perform the registration procedure for mobility and periodic registration update with Uplink data status IE except for emergency services or for high priority access;
ii) shall not initiate a service request procedure except for:
   emergency services;
   emergency services fallback;
   high priority access;
   responding to paging or responding to notification received over non-3GPP access;
iii) shall not initiate a 5GSM procedure except for:
   emergency services;
   high priority access; or
   indicating a change of 3GPP PS data off UE status; and
iv) shall not perform the NAS transport procedure except for the sending:
   SMS;
   an LPP message;
   a location services message;
   an SOR transparent container;
   a UE policy container;
   a UE parameters update transparent container; or
   a Cellular Internet of Things (CIoT) user data container.
NOTE 1: The contents of CIoT user data container can be data that is not for exception reports, or data that is for exception reports if allowed for the UE (see subclause 6.2.13).

If the UE is successfully registered to a PLMN and has a stored list of “non-allowed tracking areas”:
a) while the UE is camped on a cell which is in the registered PLMN or a PLMN from the list of equivalent PLMNs and the current TAI is not in the list of “non-allowed tracking areas”, the UE shall stay in, or enter, the state 5GMM-REGISTERED.NORMAL-SERVICE and is allowed to initiate any 5GMM and 5GSM procedures; and
b) while the current TAI is in the list of “non-allowed tracking areas”, the UE shall enter the state 5GMM-REGISTERED.NON-ALLOWED-SERVICE, and:
1) if the UE is in 5GMM-IDLE mode or 5GMM-IDLE mode with suspend indication over 3GPP access, the UE:
i) shall not include the Uplink data status IE in the registration procedure for mobility and periodic registration update except for emergency services or for high priority access;
ii) shall not perform the registration procedure for mobility and periodic registration update with Follow-on request indicator set to “Follow-on request pending”, except for:
   emergency services;
   high priority access;
   indicating a change of 3GPP PS data off UE status;
   sending an SOR transparent container;
   sending a UE policy container; or
   sending a UE parameters update transparent container; and
iii) shall not initiate a service request procedure or request the lower layers to resume a suspended connection, except for:
   emergency services;
   emergency services fallback;
   high priority access;
   responding to paging;
   responding to notification received over non-3GPP access;
   indicating a change of 3GPP PS data off UE status;
   sending an SOR transparent container;
   sending a UE policy container; or
   sending a UE parameters update transparent container; and
2) if the UE is in 5GMM-CONNECTED mode or 5GMM-CONNECTED mode with RRC inactive indication over 3GPP access, the UE:
i) shall not perform the registration procedure for mobility and periodic registration update with the Uplink data status IE except for emergency services or for high priority access;
ii) shall not initiate a service request procedure or request the lower layers to resume a suspended connection, except for:
   emergency services;
   emergency services fallback;
   high priority access; or
   responding to paging or responding to notification received over non-3GPP access;
iii) shall not initiate a 5GSM procedure except for:
   emergency services;
   high priority access; or
   indicating a change of 3GPP PS data off UE status; and
iv) shall not perform the NAS transport procedure except for the sending:
   SMS;
   an LPP message;
   a location services message;
   an SOR transparent container;
   a UE policy container;
   a UE parameters update transparent container; or
   a CIoT user data container.
NOTE 2: The contents of CIoT user data container can be data that is not for exception reports, or data that is for exception reports if allowed for the UE (see subclause 6.2.13).

The list of “allowed tracking areas”, as well as the list of “non-allowed tracking areas” shall be erased when:
a) the UE is switched off; and
b) the UICC containing the USIM is removed or an entry of the “list of subscriber data” with the SNPN identity of the SNPN is updated.

When a tracking area is added to the list of “5GS forbidden tracking areas for roaming” or to the list of “5GS forbidden tracking areas for regional provision of service” as specified in the subclauses 5.5.1.2.5 or 5.5.1.3.5, the tracking area shall be removed from the list of “allowed tracking areas” if the tracking area is already present in the list of “allowed tracking areas” and from the list of “non-allowed tracking areas” if the tracking area is already present in the list of “non-allowed tracking areas”.”

A problem has been identified with providing the allows NSSAI to the lower layers.

As noted above from TS 24.501, the UE provides the following to the lower layers (copied again from above):
“c) one or more S-NSSAIs related to an access attempt for the purpose of network slice-based random access, when the access attempt is made by the UE in 5GMM-IDLE mode or 5GMM-CONNECTED mode with RRC inactive indication, determined as follows:
i) S-NSSAI(s) triggering the initial NAS message (requested NSSAI (if any) in case of the REGISTRATION REQUEST message and S-NSSAI(s) associated with all the PDU sessions included in the Uplink data status IE (if any), PDU session status IE (if any), or Allowed PDU session status IE (if any) in case of the (CONTROL PLANE) SERVICE REQUEST message), if an access attempt occurred due to an initial NAS message;
ii) the S-NSSAI associated with the PDU session, if an access attempt occurred due to an uplink user data packet to be sent for a PDU session with suspended user-plane resources or an UL NAS TRANSPORT which carries a 5GSM message for a PDU session associated with an S-NSSAI (if any); or
iii) the allowed NSSAI (if any), if an access attempt occurred for other reason than those specified in bullets i) and ii).”

The last point quoted above requires the UE to provide the allowed NSSAI if an access attempt is made for any other reason than those listed in bullets i) and ii). In these two bullets, it is clear that there is a direct connection between a procedure and the slice (i.e. S-NSSAI in question) e.g. when the UE wants user-plane resources then it provides the S-NSSAI which is associated with the PDU session. However, providing the entire allowed NSSAI (as specified by bullet iii) for all other reasons is problematic for the following reasons:
The UE may perform an access attempt for signaling that is not related to any slice. For example, the UE may want to send Short Message Service (SMS) and hence performs the service request procedure to first transition to connected mode and then send an SMS. The SMS service is not associated with any slice and so providing the allowed NSSAI to the lower layers may erroneously cause the lower layers to use resources which are associated with the allowed NSSAI and which can be of high priority although SMS is a low priority service

Similarly, the UE may perform an access attempt to send location services message which is a service that is independent of slicing and as such the UE may end up using the wrong resources as the lower layers consider the slices in the allowed NSSAI which are not associated with the actual service that the UE wants to use

The same can be said for the case when the UE wants to send Steering of Roaming (SOR) transparent container, UE policy container, UE parameters update transparent container, etc.

Additionally, the UE may perform an access attempt to deregister from the network. According to the prior art description from TS 24.501, the UE will provide the allowed NSSAI to the lower layers which will then lead to selection of resources for random access (RACH resources) considering the slices (S-NSSAIs) of the allowed NSSAI. These slices may have prioritized resources, but the UE actually wants to completely deregister from the network and not use any slice. The prior art solution can lead to using prioritized resources although the access attempt is to deregister the UE and this is not a good solution as it consumes prioritized resources for a rather low priority procedure.

A further problem is that NSAG information provided to the lower layers only considers Protocol Data Unit (PDU) sessions for which user-plane resources are needed.

As mentioned in the excerpt from TS 24.501 above, the S-NSSAI that is provided to the lower layers considers mostly PDU sessions for which user-plane (UP) resources are to be requested (and also considers the session management signaling for the PDU session which is associated with the slice i.e. S-NSSAI). However, a UE may be using CIoT 5GS optimization for which the UE sends data over the control plane i.e. over Non-Access Stratum (NAS). Although this actually uses a PDU session with an associated slice (or S-NSSAI), the prior art solution ignores such a use case and therefore the lower layers will not get the correct information for this use-case, thereby risking that the wrong RACH resources will be used by the Radio Resource Control (RRC) layer when the NAS does not indicate the correct slice (i.e. S-NSSAI) for which an access attempt is being made.

A still further problem is that NSAG information may erroneously contain a TAI which is a non-allowed area.

In general, both the UE and network check for certain errors which may occur at in different procedures or in information elements (IEs) of NAS messages e.g. there are numerous error checks that a UE performs as part of Quality of Service (QoS) parameter handling. Another example is that a TAI may exist in different lists where even though it should only be part of one list.

Another problematic situation is that a UE may receive a TAI which is in the service area restriction list such that it is considered to be a non-allowed area, and at the same time the TAI is in the NSAG information which the UE receives. Receiving a non-allowed TAI in the NSAG information may wrongly lead a UE to consider that the slice is accessible for user plane resources or session management signaling although the service area restrictions prohibits the UE from using the associated PDU session or establish a PDU session for that slice when in the non-allowed area. Such a situation may lead to inconsistencies, which could lead to non-defined or erroneous operation. It is desirable that such a situation is resolved in order to have a consistent set of requirements that don't appear to contradict each other.

To give a further example of this, a UE may have a so called always-on PDU session which requires user-plane (UP) resources to be established at any time when the UE is in connected mode. This normally puts a requirement on the UE to always request UP resource establishment (by including the Uplink data status IE, in which the UP resource establishment is requested) at every time the UE transitions to connected mode. However, this requirement is dropped when the UE is in a non-allowed area such that the UE must not request UP resources in a non-allowed area even for an always-on PDU session as quoted below from section 5.6.1.2.1 of TS 24.501:
“When the UE is in a non-allowed area or is not in an allowed area as specified in subclause 5.3.5 and:
a) if the uplink signaling pending is to indicate a change of 3GPP PS data off UE status for a PDU session, the UE shall set the service type IE in the SERVICE REQUEST message to “elevated signaling”, and shall not include the Uplink data status IE in the SERVICE REQUEST message even if the UE has one or more active always-on PDU sessions associated with the access type over which the SERVICE REQUEST message is sent; or
b) otherwise, the UE shall not initiate service request procedure except for emergency services, high priority access or responding to paging or notification.”

From the above, it can be concluded that although there are certain expectations or requirements that are generally to be enforced, the UE verifies other conditions which may then require a change in UE behavior. The same can be said for the problem that has been described above i.e. receiving a TAI in the NSAG even though the TAI is part of the non-allowed area.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method for determining whether to provide at least one single network slice selection assistance information (S-NSSAI) related to the access attempt from a non-access stratum (NAS) layer to a lower layer based on the reason for an access attempt.

Additional aspects will be set forth in part in the description which follows and, in part, will be apparent from the description, or may be learned by practice of the presented embodiments.

In accordance with an aspect of the disclosure, a method performed by a User Equipment (UE) in a wireless communication system is provided. The method includes identifying, by the UE, a reason for an access attempt, and determining, by the UE, based on the reason for the access attempt, whether to provide at least one single network slice selection assistance information (S-NSSAI) related to the access attempt from a non-access stratum (NAS) layer to a lower layer.

In accordance with another aspect of the disclosure, in case that the reason for the access attempt is associated with sending cellular internet of things (CIoT) user data, the at least one S-NSSAI related to the access attempt is provided by the NAS layer to the lower layer

In accordance with another aspect of the disclosure, no S-NSSAI is provided by the NAS layer to the lower layer if the access attempt is for one of the following:
a deregistration procedure;
UE-initiated NAS transport procedure for sending a Short Message, SMS;
UE-initiated NAS transport procedure for sending LTE Positioning Protocol (LPP);
UE-initiated NAS transport procedure for sending Steering of Roaming, SOR;
UE-initiated NAS transport procedure for sending UE policy container;
UE-initiated NAS transport procedure for sending UE parameters update transparent container; or
UE-initiated NAS transport procedure for sending location services message.

In an embodiment, no S-NSSAI is provided either by an absence of information within a message or by a positive indication that no slice information is to be provided.

In an embodiment, the UE is in 5G mobile management (5GMM)-IDLE mode or 5GMM-CONNECTED mode with RRC inactive indication.

In accordance with another aspect of the disclosure, a user equipment (UE) in a wireless communication system is provided. The UE includes a transceiver configured to receive and transmit a signal, memory, and one or more processors communicatively coupled to the transceiver and the memory. The memory store one or more computer programs including computer-executable instructions that, when executed by the one or more processors, cause the UE to identify a reason for an access attempt, and determine, based on the reason for the access attempt, whether to provide at least one single network slice selection assistance information (S-NSSAI) from a non-access stratum (NAS) layer to a lower layer.

In accordance with another aspect of the disclosure, one or more non-transitory computer-readable storage media storing one or more computer programs including computer-executable instructions that, when executed by one or more processors of an electronic device, cause the electronic device to perform operations are provided. The operations include identifying, by the UE, a reason for an access attempt; and determining, by the UE, based on the reason for the access attempt, whether to provide at least one single network slice selection assistance information (S-NSSAI) related to the access attempt from a non-access stratum (NAS) layer to a lower layer.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a flowchart according to an embodiment of the disclosure;

FIG. 2 shows a flowchart according to an embodiment of the disclosure; and

FIG. 3 illustrates a structure of a user equipment (UE) according to embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In a first embodiment, the UE verifies if the access attempt is for a service which is not related to a slice in order to determine if any S-NSSAI should be provided to the lower layers.

When the UE is performing an access attempt for any reason which is not related to any slice (i.e. S-NSSAI) e.g. to send an SMS, location services message, LTE Positioning Protocol (LPP) message, then the UE should not provide any S-NSSAI to the lower layers i.e. the UE does not indicate any S-NSSAI for which the access attempt is being made in this case.

The above is applicable for any of the following reasons for access attempt i.e. when the UE wants to send any one or combination of the following:
SMS
Location services message
LPP
an SOR transparent container
UE policy container
UE parameters update transparent container
Service-level-AA container
Multiple payloads
Or any other container or IE which may be defined in the future and which is not related to any S-NSSAI (or which is not related with any PDU session that is in turn associated with an S-NSSAI)
NAS messages as listed in 3GPP TS 24.501

Optionally, the UE (e.g. the NAS) provides the S-NSSAI to the lower layers when it is performing an access attempt to send a service-level-AA container where the S-NSSAI is that which is associated with the PDU session which was used to transfer this information. In other words, if the service-level-AA container was exchanged between the UE and the network using the PDU session establishment procedure, or the PDU session modification procedure, then the UE (e.g. NAS) determines the S-NSSAI as the S-NSSAI associated with that PDU session when an access attempt is being made to send service-level-AA container and hence provides the S-NSSAI to the lower layers.

Optionally, the UE (e.g. the NAS) provides an indication to the lower layers that UE is making an attempt for service/attempting to send a NAS message which is not related to any of the S-NSSAI for e.g. registration request message or deregistration request.

In another option the UE-NAS can send at least one indication to the lower layers (when both the service/NAS message not related to signaling and data/service/NAS message related to signaling is pending):
a) that UE is making an attempt for service/attempting to send a NAS message which is not related to any of the S-NSSAI; and
b) that UE is making an attempt for service/attempting to send a NAS message which is related to at least one of the S-NSSAI and includes at least one of the Allowed S-NSSAI, Requested S-NSSAI, partially allowed S-NSSAI or partially rejected S-NSSAI

However, an exception to the above is as follows: if the UE, in addition to the services listed above, also requires to request UP resources for at least one PDU session, then the UE will indicate the S-NSSAI for any of the PDU session for which UP resources is required (e.g. by virtue of requesting UP resources in the Uplink data status IE or Allowed PDU session status IE) and providing the S-NSSAI to the lower layers.

The above should also apply for the case when the UE wants to deregister form the network i.e. when the UE performs an access attempt in order to send deregistration request message

Note that all of the above applies for the case in which the UE is either in 5GMM-IDLE mode or in 5GMM-CONNECTED mode with RRC inactive indication.

As an example, the following changes (shown as underlined text) may be made to the specifications to implement the proposals above:
“The NSAG information provided by the network and stored in the UE includes a list of NSAGs each of which contains:
a) an NSAG ID;
b) a list of S-NSSAI(s), which are associated with the NSAG and shall be part of the configured NSSAI;
c) a priority value that is associated with the NSAG; and
d) optionally a list of TAIs in which the NSAG is valid. If it is not provided by the network, the NSAG is valid in the PLMN which has sent the NSAG information.

The UE NAS layer shall provide the lower layers with.
a) the most recent NSAG information stored in the UE (see subclause 4.6.2.2);
b) the allowed NSSAI or the requested NSSAI for the purpose of network slice-based cell reselection (see 3GPP TS 23.501 [8]); and
c) one or more S-NSSAIs related to an access attempt for the purpose of network slice-based random access, when the access attempt is made by the UE in 5GMM-IDLE mode or 5GMM-CONNECTED mode with RRC inactive indication, determined as follows:
i) S-NSSAI(s) triggering the initial NAS message (requested NSSAI (if any) in case of the REGISTRATION REQUEST message and S-NSSAI(s) associated with all the PDU sessions included in the Uplink data status IE (if any), PDU session status IE (if any), or Allowed PDU session status IE (if any) in case of the (CONTROL PLANE) SERVICE REQUEST message), if an access attempt occurred due to an initial NAS message;
ii) the S-NSSAI associated with the PDU session, if an access attempt occurred due to an uplink user data packet to be sent for a PDU session with suspended user-plane resources or an UL NAS TRANSPORT which carries a 5GSM message for a PDU session associated with an S-NSSAI (if any); or
iii) the allowed NSSAI (if any), if an access attempt occurred for other reason than those specified in bullets i) and ii) and the access attempt is not for sending any of the following: SMS, Location services message, LPP, an SOR transparent container, a UE policy container, a UE parameters update transparent container, and optionally a Service-level-AA container.
Editor's note: It is FFS how a UE operates in terms of NSAG if the UE has an emergency PDU session or attempts to establish an emergency PDU session.
NOTE: The AMF can take local configuration, UE 5GMM capabilities, subscribed S-NSSAIs, HPLMN, etc. to determine the NSAG priority information for the associated NSAG to a UE.”

In a second embodiment, the UE also provides an S-NSSAI to the lower layers if it is performing an access attempt to send data over NAS.

The prior art standards description ignores the case in which the UE performs an access attempt to send data over NAS for Cellular Internet of Things (CIoT).

Therefore, when the UE wants to perform an access attempt for the purpose of sending data over NAS, then the UE (e.g. NAS) should determine the S-NSSAI for the access attempt as the S-NSSAI which is associated with the PDU session for which the data is being sent (or for which the data needs to be sent) and, as such, the NAS should provide the S-NSSAI to the lower layer which corresponds to this PDU session. It should be noted that this solution would apply for the case when the UE wants to send data over NAS using either the CONTROL PLANE SERVICE REQUEST message, or the UL NAS TRANSPORT message (where the Payload container type IE indicates “CIoT user data container”). The details herein apply for the case when the UE is in 5GMM-IDLE mode (e.g. for the case of CONTROL PLANE SERVICE REQUEST) or in 5GMM-CONNECTED mode with RRC-inactive indication (e.g. for the case of UL NAS TRANSPORT).

For example, the following changes (shown as underlined text) may be made to the specifications to implement the proposals above:

“The NSAG information provided by the network and stored in the UE includes a list of NSAGs each of which contains:
a) an NSAG ID;
b) a list of S-NSSAI(s), which are associated with the NSAG and shall be part of the configured NSSAI;
c) a priority value that is associated with the NSAG; and
d) optionally a list of TAIs in which the NSAG is valid. If it is not provided by the network, the NSAG is valid in the PLMN which has sent the NSAG information.

The UE NAS layer shall provide the lower layers with.
a) the most recent NSAG information stored in the UE (see subclause 4.6.2.2);
b) the allowed NSSAI or the requested NSSAI for the purpose of network slice-based cell reselection (see 3GPP TS 23.501 [8]); and
c) one or more S-NSSAIs related to an access attempt for the purpose of network slice-based random access, when the access attempt is made by the UE in 5GMM-IDLE mode or 5GMM-CONNECTED mode with RRC inactive indication, determined as follows:
i) S-NSSAI(s) triggering the initial NAS message (requested NSSAI (if any) in case of the REGISTRATION REQUEST message and S-NSSAI(s) associated with all the PDU sessions included in the Uplink data status IE (if any), PDU session status IE (if any), or Allowed PDU session status IE (if any) in case of the (CONTROL PLANE) SERVICE REQUEST message), if an access attempt occurred due to an initial NAS message;
ii) the S-NSSAI associated with the PDU session, if an access attempt occurred due to an uplink user data packet to be sent for a PDU session with suspended user-plane resources or an UL NAS TRANSPORT which carries a 5GSM message for a PDU session associated with an S-NSSAI (if any); or
iii) the S-NSSAI associated with the PDU session if an access attempt occurred for sending CIoT user data in a CONTROL PLANE SERVICE REQUEST message or in an UL NAS TRANSPORT message
iiiiv) the allowed NSSAI (if any), if an access attempt occurred for other reason than those specified in bullets i) and ii) and the access attempt is not for sending any of the following: SMS, Location services message, LPP, an SOR transparent container, a UE policy container, a UE parameters update transparent container, and optionally a Service-level-AA container.
Editor's note: It is FFS how a UE operates in terms of NSAG if the UE has an emergency PDU session or attempts to establish an emergency PDU session.
NOTE: The AMF can take local configuration, UE 5GMM capabilities, subscribed S-NSSAIs, HPLMN, etc. to determine the NSAG priority information for the associated NSAG to a UE.”

Note that the above applies when the UE wants to send CIoT user data where this data may be sent inside any IE of the NAS message. For example, the CIoT user data may be sent inside a CIoT small data container, or inside the Payload container where optionally the Payload container type indicates “CIoT user data container”.

In a third embodiment, the UE removes any TAI from the NSAG information if the TAI is considered to be a non-allowed TAI.

Here, the UE should verify if any of the TAIs in the NSAG is also present in the Service area list IE and is considered to be a non-allowed area, or the TAI is considered to be a non-allowed area even if the TAI is not part of the Service area list IE (e.g. where the TAIs in the IE are indicated as allowed TAI and hence any other TAI is considered to be a non-allowed TAI).

If this is the case, i.e. if the UE detects that a TAI in the NSAG is considered to be part of a non-allowed area (or outside the allowed area), then the UE should remove the TAI from the NSAG information. Optionally the UE also removes the associated S-NSSAIs which correspond to this TAI.

Alternatively, when the UE is inside any non-allowed area (or not inside an allowed area), the UE does not provide any S-NSSAI to the lower layers i.e. the UE determines that an access attempt in a non-allowed area (or outside of an allowed area) is not triggered by any S-NSSAI. Alternatively, in this case, the UE provides the requested NSSAI or the allowed NSSAI as the S-NSSAIs that triggered the access attempt.

Alternatively, the UE can remove the TAIs from non-allowed area list and consider the TAIs as allowed TAIs when those are included as part of NSAG information. Yet another way of implementing this is to retain the TAIs in non-allowed area list but the UE can ignore the respective information and treat the TAIs as allowed TAIs.

However, an exception to the above may be when the UE is considered to be a high priority access UE in which case it will determine the S-NSSAI for which the access attempt is being made according to the existing rules and hence provide the S-NSSAIs to the lower layers accordingly.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

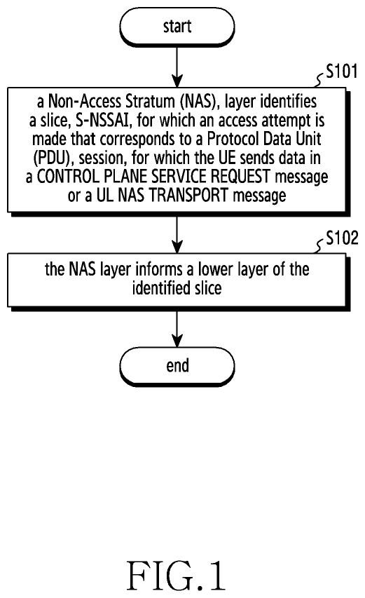

FIG. 1 shows a flowchart according to an embodiment of the disclosure.

Referring to FIG. 1, at operation 8101, a Non-Access Stratum (NAS), layer identifies a slice, S-NSSAI, for which an access attempt is made that corresponds to a Protocol Data Unit (PDU), session, for which the UE sends data in a CONTROL PLANE SERVICE REQUEST message or a UL NAS TRANSPORT message. At operation S102, the NAS layer informs a lower layer of the identified slice.

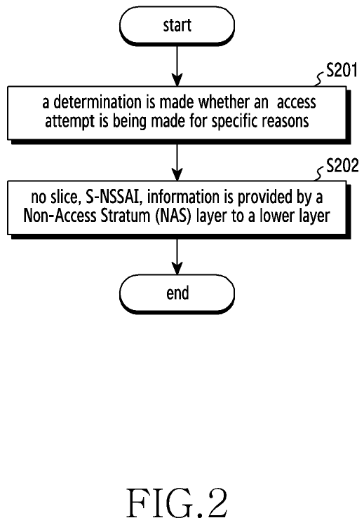

FIG. 2 shows a flowchart according to an embodiment of the disclosure.

Referring to FIG. 2, at operation S201, a determination is made whether one of the following access attempts is being made:
a) a deregistration procedure;
b) UE-initiated NAS transport procedure for sending a Short Message Service (SMS);
c) UE-initiated NAS transport procedure for sending LTE Positioning Protocol (LPP);

d) UE-initiated NAS transport procedure for sending Steering of Roaming (SOR);

e) UE-initiated NAS transport procedure for sending UE policy container;

f) UE-initiated NAS transport procedure for sending UE parameters update transparent container; or

g) UE-initiated NAS transport procedure for sending location services message.

At operation S202, no slice, S-NSSAI, information is provided by a Non-Access Stratum (NAS) layer to a lower layer. In the context of this embodiment, no slice, S-NSSAI, information is provided either by an absence of information within a message or by a positive indication that no slice information is to be provided.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

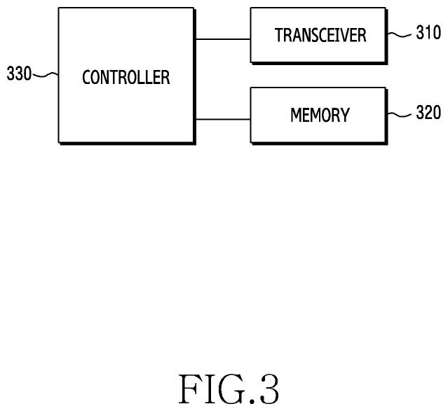

FIG. 3 illustrates a structure of a user equipment (UE) according to embodiments of the disclosure.

As shown in FIG. 3, the UE according to an embodiment may include a transceiver 310, a memory 320, and a processor 330. The transceiver 310, the memory 320, and the processor 330 of the UE may operate according to a communication method of the UE described above. However, the components of the UE are not limited thereto. For example, the UE may include more or fewer components than those described above. In addition, the processor 330, the transceiver 310, and the memory 320 may be implemented as a single chip. Also, the processor 330 may include at least one processor.

The transceiver 310 collectively refers to a UE receiver and a UE transmitter, and may transmit/receive a signal to/from a base station or a network entity. The signal transmitted or received to or from the base station or a network entity may include control information and data. The transceiver 310 may include a RF transmitter for up-converting and amplifying a frequency of a transmitted signal, and a RF receiver for amplifying low-noise and down-converting a frequency of a received signal. However, this is only an example of the transceiver 310 and components of the transceiver 310 are not limited to the RF transmitter and the RF receiver.

Also, the transceiver 310 may receive and output, to the processor 330, a signal through a wireless channel, and transmit a signal output from the processor 330 through the wireless channel.

The memory 320 may store a program and data required for operations of the UE. Also, the memory 320 may store control information or data included in a signal obtained by the UE. The memory 320 may be a storage medium, such as read-only memory (ROM), random access memory (RAM), a hard disk, a CD-ROM, and a DVD, or a combination of storage media.

The processor 330 may control a series of processes such that the UE operates as described above. For example, the transceiver 310 may receive a data signal including a control signal transmitted by the base station or the network entity, and the processor 330 may determine a result of receiving the control signal and the data signal transmitted by the base station or the network entity.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
identifying an access attempt occurred due to a reason; and
determining, based on the reason for the access attempt, whether to provide at least one single network slice selection assistance information (S-NSSAI) related to the access attempt from a non-access stratum (NAS) layer to a lower layer.

2. The method of claim 1, further comprising, in case that the reason for the access attempt is associated with sending cellular internet of things (CIoT) user data, providing the at least one S-NSSAI related to the access attempt from the NAS layer to the lower layer.

3. The method of claim 2, wherein the CIoT user data is included in a control plane service request message or an uplink (UL) NAS transport message.

4. The method of claim 3, wherein the at least one S-NSSAI is associated with a protocol data unit (PDU) session.

5. The method of claim 1, wherein the access attempt is performed by the UE in a fifth-generation mobility management (5GMM) idle mode or a 5GMM connected mode with a radio resource control (RRC) inactive indication.

6. The method of claim 1, wherein, in case that the reason for the access attempt is associated with a deregistration procedure, no S-NSSAI is provided from the NAS layer to the lower layer.

7. The method of claim 1, wherein, in case that the reason for the access attempt is associated with a UE-initiated NAS transport procedure for sending at least one of a short message (SMS), long term evolution (LTE) positioning protocol (LPP) message, steering of roaming (SOR), UE policy container, UE parameters update transparent container or location service message, no S-NSSAI is provided from the NAS layer to the lower layer.

8. The method of claim 1, further comprising, in case that the reason for the access attempt is associated with at least one of: a service-level-AA container, a protocol data unit (PDU) session modification procedure or a user plane (UP) resource, providing the at least one S-NSSAI from the NAS layer to the lower layer.

9. The method of claim 1, further comprising:
receiving network slice access group (NSAG) information,
wherein the NSAG information includes the at least one S-NSSAI related to the access attempt.

10. The method of claim 9, wherein the NSAG information includes S-NSSAI triggering an initial NAS message.

11. A user equipment (UE) in a wireless communication system, the UE comprising:
a transceiver; and
one or more processor coupled with the transceiver and configured to:
identify an access attempt occurred due to a reason; and
determine, based on the reason for the access attempt, whether to provide at least one single network slice selection assistance information (S-NSSAI) from a non-access stratum (NAS) layer to a lower layer.

12. The UE of claim 11, wherein, in case that the reason for the access attempt is associated with sending cellular internet of things (CIoT) user data, the processor further configured to provide the at least one S-NSSAI from the NAS layer to the lower layer.

13. The UE of claim 12, wherein the CIoT user data is included in a control plane service request message or an uplink (UL) NAS transport message.

14. The UE of claim 13, wherein the at least one S-NSSAI is associated with a protocol data unit (PDU) session.

15. The UE of claim 11, wherein the access attempt is performed by the UE in a fifth-generation mobility management (5GMM) idle mode or a 5GMM connected mode with a radio resource control (RRC) inactive indication.

16. The UE of claim 11, wherein, in case that the reason for the access attempt is associated with a deregistration procedure, no S-NSSAI is provided from the NAS layer to the lower layer.

17. The UE of claim 11, wherein, in case that the reason for the access attempt is associated with a UE-initiated NAS transport procedure for sending at least one of: a short message (SMS), long term evolution (LTE) positioning protocol (LPP) message, steering of roaming (SOR), UE policy container, UE parameters update transparent container or location service message, no S-NSSAI is provided from the NAS layer to the lower layer.

18. The UE of claim 11, wherein, in case that the reason for the access attempt is associated with at least one of: a service-level-AA container, a protocol data unit (PDU) session modification procedure or a user plane (UP) resource, the processor further configured to provide the at least one S-NSSAI from the NAS layer to the lower layer.

19. The UE of claim 11, wherein the processor further configured to receive network slice access group (NSAG) information, and
wherein the NSAG information includes the at least one S-NSSAI related to the access attempt.

20. The UE of claim 19, wherein the NSAG information includes S-NSSAI triggering an initial NAS message.
